(19) United States
(12) Patent Application Publication
(10) Pub. No.: US 2012/0158203 A1
(43) Pub. Date: Jun. 21, 2012

(54) Personal Energy Management System

(75) Inventor: George Feldstein, Cresskill, NJ (US)

(73) Assignee: Crestron Electronics, Inc., Rockleigh, NJ (US)

(21) Appl. No.: 13/327,078

(22) Filed: Dec. 15, 2011

Related U.S. Application Data
(60) Provisional application No. 61/424,288, filed on Dec. 17, 2010.

(51) Int. Cl. G06F 1/32

(52) U.S. Cl. 700/295; 713/320

(57) ABSTRACT

Presented is a system for managing energy usage of a user. The system includes a database storing a preferred energy profile associated with the user and a minimum energy profile, an automation control system that controls at least one device associated with the user, a presence detecting apparatus for detecting when the user is present, and a system control computer. The system control computer instructs the automation control system to operate the one device according to the preferred energy profile associated with the user in response to the presence detecting apparatus detecting the presence of the user. The system control computer further instructs the automation control system to operate the one device according to the minimum energy profile in response to the presence detecting apparatus detecting the absence of the user.

### BACKGROUND OF THE INVENTION

1. Technical Field

The present invention relates generally to energy management, and more particularly to monitoring and managing the energy usage of one or more individuals.

2. Background Art

In typical office buildings, various environmental conditions, such as lighting and HVAC, are set to levels that are satisfactory to a theoretical average employee, and left unmonitored. For example, a building thermostat is automatically set at a particular temperature for the work day and a different temperature for nights, weekends, and holidays. However, the temperature for a theoretically average employee is often not satisfactory for an actual employee. Consequently, many employees must work in an environment that is either too hot or too cold. In this case, a particular employee may open a window or use an electric fan to cool down, or use an electric heater to warm up, thus wasting heat and/or electricity.

Further, all the lights in a predefined zone (e.g., floor, wing, suite) in an office building are often automatically set to be on during the day (whether needed or not) and off during the night and weekends. However, in this configuration, if one employee is working at night or on the weekend, the only option is to turn on all the lights in the predefined zone. Alternatively, the lights in an office building are turned on and off at the whimsy of employees. Consequently, lights are often left on indefinitely, regardless of whether or not employees are actually in the office.

In a domestic setting, many people typically pay no attention to their use of electricity, heat, or air conditioning. Consequently, such people waste energy and pay exorbitant electric and/or oil bills.

Therefore, a need exists for a system that automatically configures the environment al settings for a particular person when the particular person is present, and minimizes energy usage when the particular person is absent.

### SUMMARY OF THE INVENTION

It is to be understood that both the general and detailed descriptions that follow are exemplary and explanatory only and are not restrictive of the invention.

According to one aspect, the invention involves a system for managing energy usage of a user. The system includes a database configured for storing a preferred energy profile associated with the user, and a minimum energy profile. The system further includes an automation control system configured for controlling at least one device associated with the user, a presence detecting apparatus configured for detecting when the user is present, and a system control computer in communication with the automation control system and the presence detecting apparatus. The system control computer is configured for instructing the automation control system to operate the at least one device according to the preferred energy profile associated with the user in response to the presence detecting apparatus detecting the presence of the user. The system control computer is also configured for instructing the automation control system to operate the at least one device according to the minimum energy profile in response to the presence detecting apparatus detecting the absence of the user.

According to another aspect, the invention involves a method of managing energy usage of a user. The method includes storing in a database a preferred energy profile associated with the user, and a minimum energy profile. The method further includes detecting the presence of the user in a particular location, retrieving the preferred energy profile associated with the user in response to detecting the presence of the user in the particular location, operating one or more devices disposed in the particular location according to the retrieved preferred energy profile, retrieving the minimum energy profile in response to detecting the absence of the user from the particular location, and operating the one or more devices disposed in the particular location according to the retrieved minimum energy profile.

According to still another aspect, the invention involves a system for configuring a user's environment within a building. The system includes a database configured for storing a preferred energy profile associated with the user, and a minimum energy profile. The system further includes an automation control system configured for controlling a plurality of devices associated with the user, where at least some of the plurality of devices are disposed in separate rooms of the building. The system still further includes at least one presence detecting apparatus configured for detecting when the user is present in the building, and a system control computer in communication with the automation control system and the at least one presence detecting apparatus. The system control computer is configured for instructing the automation control system to operate the plurality of devices according to the preferred energy profile associated with the user in response to the at least one presence detecting apparatus detecting the presence of the user in the building. The system control computer is also configured for instructing the automation control system to operate the plurality of devices according to the minimum energy profile in response to the presence detecting apparatus detecting the absence of the user from the building.

### BRIEF DESCRIPTION OF THE DRAWINGS

The accompanying figures further illustrate the present invention. Exemplary embodiments are illustrated in reference figures of the drawings. It is intended that the embodiments and figures disclosed herein are to be considered to illustrative rather than limiting.

The components in the drawings are not necessarily drawn to scale, emphasis instead being placed upon clearly illustrating the principles of the present invention. In the drawings, like reference numerals designate corresponding parts throughout the several views.

FIG. 1 is an illustrative block diagram of a personal energy management system for a corporate environment, according to one embodiment of the invention.

FIG. 2 is an illustrative block diagram of an office floor employing the personal energy management system of FIG. 1.

FIG. 3 is an illustrative block diagram of a personal energy management system for a domestic environment, according to one embodiment of the invention.

FIG. 4 is an illustrative block diagram of residential home employing the personal energy management system of FIG. 3.

### LIST OF REFERENCE NUMBERS FOR THE MAJOR ELEMENTS IN THE DRAWING

The following is a list of the major elements in the drawings in numerical order.
100 personal energy management system
102 system control computer
104 profile database
106 RFID reader
108 wireless signal repeater
110 wireless receiver/transmitter
112 motion sensor
114 camera
116 LAN
118 internet
119 wireless access point
120 personal computer
122 automation control system
124 wireless light control/dimmer
126 smartphone
128 RFID badge
130 personal remote control device
132 HVAC
134 lighting
136 shades
138 phones
140 audio/video components
142 computers
144 security
200 office building level
202 reception area
204a-c corner office
206a-f secretary station
208a-k office
210 men's room
212 women's room
214 file room
216a-b conference room
218 break room
220a-e hallways
222a-b presence detecting apparatus
300 personal energy management system
302 system control computer
304 profile database
306 RFID reader
308 wireless signal repeater
310 wireless receiver/transmitter
312 motion sensor
314 camera
316 router
318 internet
320 personal computer
322 automation control system
324 wireless light control/dimmer
326 smartphone
328 RFID badge
330 personal remote control device
332 HVAC
334 lighting
336 shades
338 home theater
340 home audio
344 security
400 house floor
402 bedroom
404 bedroom
406 bedroom
408 living room
410 bathroom
412 bathroom
416 dining room
418 kitchen
420 hallway
422 foyer
424a-g presence detecting apparatus

### DETAILED DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

### MODE(S) FOR CARRYING OUT THE INVENTION

The present invention involves a system for monitoring and managing the energy usage of individuals or groups of individuals in a variety of environments. The energy usage of the individuals or groups of individuals is configured and controlled according to preferences defined in personal energy profiles.

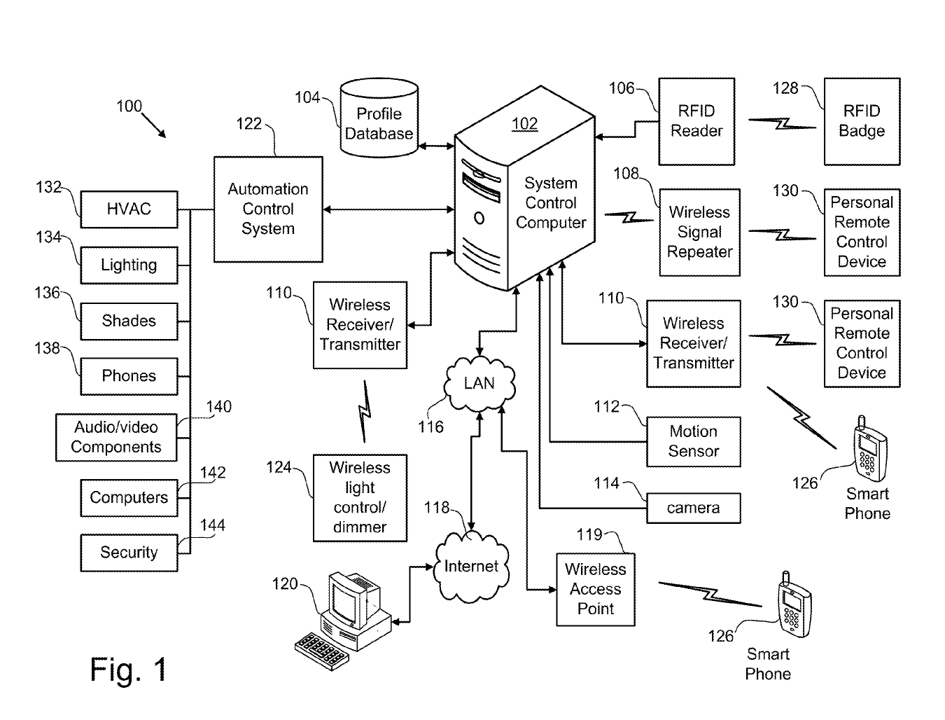

Referring to FIG. 1, in one embodiment, a personal energy management (PEM) system 100 in a corporate/industrial environment is shown. The system 100 includes a system control computer 102, a profile database 104, and an automation control system 122. In various embodiments, the personal energy management system 100 further includes at least one RFID reader 106, at least one wireless signal repeater 108 (e.g., an IR signal repeater), at least one wireless receiver/transmitter 110 (e.g., an IR receiver/transmitter), at least one motion sensor 112, and at least one camera 114. In various embodiments, a plurality of RFID readers 106, and/or a plurality of wireless signal repeaters 108, and/or a plurality of wireless receiver/transmitters 110, and/or a plurality of motion sensors 112, and/or a plurality of cameras 114 are disposed throughout a building employing the PEM system 100.

The automation control system 122 controls HVAC 132, outlet (A/C) power, humidity, lighting 134, wireless light controllers/dimmers 124, window shades/drapes 136, phones 138, computers 142, audio/video (A/V) 140 components (e.g., digital signs and displays, public address system, lobby and elevator music), and security/emergency systems 144. The system control computer 102 is in wired or wireless communication with the at least one RFID reader 106, the at least one wireless signal repeater 108, the at least one wireless receiver/transmitter 110, the at least one motion sensor 112, and the at least one camera 114. The system control computer 102 includes software, which resides and executes thereon, that is used to configure and control the PEM system 100. Such software is written in any acceptable computer language known to those skilled in the art.

The profile database 104 is used to store personal energy management (PEM) profiles and various default energy management profiles, which are discussed in detail below. In one embodiment, the profile database 104 is stored separately from the system control computer 102. In another embodiment, the profile database 104 is stored on the system control computer 102. The system control computer 102 is also in wired or wireless communication with a local area network (LAN) 116, which is, in turn, in wired or wireless communication with a wide area network (WAN), such as the internet 118 or World Wide Web. The system control computer 102 can be accessed and configured directly through a connected terminal or remotely via a connected personal computer 120.

Each employee (i.e., user) has a personal energy management profile stored in the profile database 104. The employee's PEM profile includes data and preferences relating to the employee's work environment. Such data and preferences include, but are not limited to, office location, work schedule, nearest rest room used by the employee, nearest copier/printer/fax machine used by the employee, preferred office temperature, preferred office light levels (e.g., on, off, percent dimmed), and preferred shade or drape position (e.g., open, closed, percent open). In one embodiment, each employee can configure their own PEM profile stored in the profile database 104 via any computer/terminal or smart phone in communication with the company LAN 116, or via a computer/terminal 120 or smart phone 126 in communication with the internet 118. In another embodiment, a system administrator creates and configures all the profiles stored in the profile database 104.

Default energy management profiles are also stored in the profile database 104. The default profiles are used to configure the work environment for minimum energy usage when employees are absent, such as during weekends, holidays, and non work hours. A default profile is also used to configure a particular employee's work environment for minimum energy usage during normal work hours when the particular employee is absent (e.g., sick, on vacation, working off-site). In another embodiment, the default settings for the devices in the employee's work environment are included in the employee's personal energy management profile.

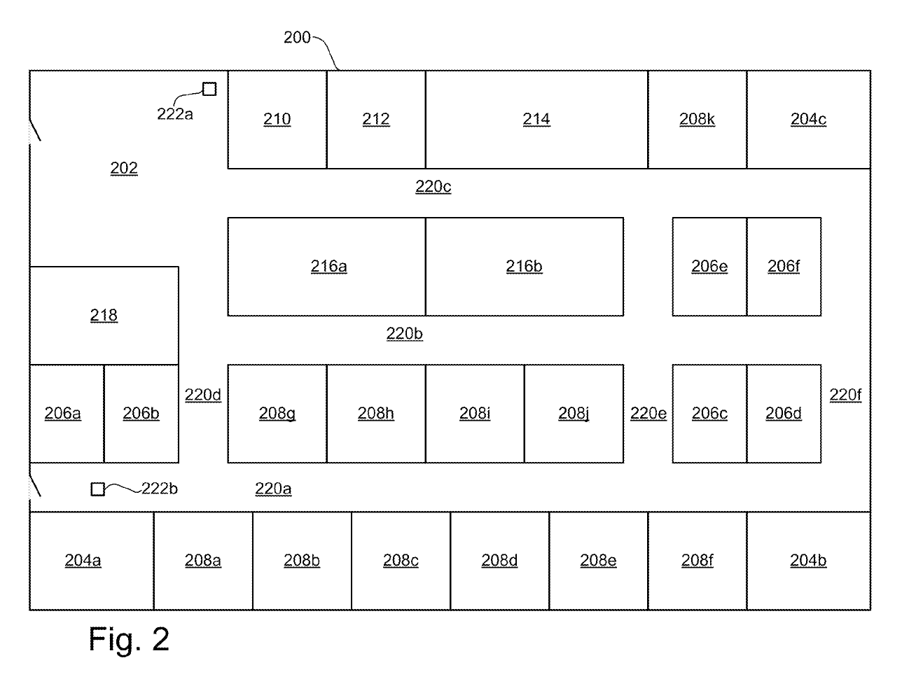

Referring to FIG. 2, an illustrative block diagram of a floor/level 200 of an office building is shown. The level 200 includes a reception area 202, corner offices 204a-c, non-corner offices 208a-k, secretary stations 206a-f, a men's room 210, a women's room 212, a file room 214, conference rooms 216a-b, hallways 220a-e, and a break room 218.

Disposed at various locations throughout the level 200 are employee presence detecting devices or apparatuses 222a-b. In various embodiments, each presence detecting apparatus 222a-b is the RFID reader 106, the wireless signal repeater 108, the wireless receiver/transmitter 110, the motion sensor 112, or the camera 114 mentioned above with respect to FIG. 1, or a wireless access point 119.

In operation, when the employee enters an office building level 200, the employee makes his/her presence known to (i.e., registers with) the PEM system 100 by interacting with the presence detecting apparatus 222a-b. In one embodiment, interacting with the presence detecting apparatus 222a-b involves the employee actuating a wireless personal remote control device 130, such as an infrared, Wi-Fi, or Bluetooth remote control, for example, and transmitting a unique digital presence signal, which is detected/received by one of the wireless receiver/transmitters 110 disposed throughout the building for floor 200. The wireless receiver/transmitter 110 then transmits the unique digital presence signal to the system control computer 102. In another embodiment, the signal from the employee's personal remote control device 130 is read by a wireless signal repeater 108 and passed to the system control computer 102.

In still another embodiment, interacting with the presence detecting apparatus 222a-b involves the employee presenting his/her personal RFID badge 128 to the RFID reader 106. The RFID reader 106 detects/reads the employee's personal RFID badge 128 and transmits the unique digital presence signal to the system control computer 102. For example, the employee's RFID badge 128 could be part of the employee's identification card and read by the RFID reader 106 when the employee operates a cardkey access door.

In yet another embodiment, interacting with the presence detecting apparatus 222a-b involves the employee connecting to (logging on to) the company LAN 116 with a Wi-Fi enabled smart phone 126 via a wireless access point 119

In still another embodiment, interacting with the presence detecting apparatus 222a-b involves the employee being detected by the motion detectors 112. In this embodiment, sustained motion detected in an office/cube/lab is an indication that the employee assigned to that office/cube/lab is present. Brief motion detection would be interpreted as a visitor entering the office, such as a mail clerk or secretary.

In yet another embodiment, interacting with the presence detecting apparatus 222a-b involves the employee being detected by the cameras 114. The cameras 114 function in conjunction with facial recognition software residing and executing on the system control computer 102. In this embodiment, prior to entering the office building, or as security requirement for entry, an employee would be required to look directly at a camera and wait until the facial recognition software made a positive identification.

Upon receiving the employee's unique digital presence signal, the system control computer 102 retrieves a corresponding employee PEM profile from the profile database 104. The system control computer 102 uses the data and preferences in the employee's PEM profile to instruct the automation control system 122 to configure the environment in the employee's office/cube/lab/work area. For example, if the employee prefers a brightly lit office, with natural light, and a temperature of 75 degrees Fahrenheit, the system control computer 102 instructs the automation control system 122 to adjust the lighting, shade position, and temperature in the employee's office accordingly. The system control computer 102 also instructs the automation control system 122 to turn on the employee's computer and phones, and any other peripheral devices that the employee uses, such as printers, copiers, fax machines, etc.

Still referring to FIG. 2, as a further example, assume two employees (employee A and employee B) enter the reception area 202. Further assume that employee A works in office 204c and employee B works in office 208h. Upon the two employees entering the reception area 202, the presence detecting apparatus 222a detects the presence of both employees through one of the methods described in detail above.

The system control computer 102 retrieves the profiles for employee A and employee B from the profile database 104. The system control computer 102 then instructs the automation control system 122 to adjust the lighting, shade position, and temperature in office 204c according employee A's profile and instructs the automation control system 122 to adjust the lighting, shade position, and temperature in office 208h according employee B's profile. The system control computer 102 also instructs the automation control system 122 to turn on any respective devices assigned to employee A and employee B, such as a computer, a phone, and any other peripheral devices (e.g., a printer).

In one embodiment, when a particular employee (e.g., employee A or B) leaves the building for lunch, or other appointment, the employee either alerts the system control computer 102 of his departure (i.e., imminent absence) using his/her personal remote control 130, or RFID badge 128. In another embodiment, the system control computer 102 is alerted to the employee's departure/absence when the employee's smart phone 126 is disconnected from the company LAN 116.

Upon detecting the employee's departure/absence, the system control computer 102 retrieves a default profile from the database 104. The system control computer 102 then, according to the default profile, instructs the automation control system 122 to turn off the employee's office lights, adjust the employee's office temperature to a predetermined “unoccupied” setting, and put the employee's computer and other peripherals in standby or sleep mode, or turn them off completely.

When the employee returns to the office building from lunch or other appointment, the employee again makes his/her presence known to (i.e., reconnects with) the PEM system 100 as described above. The system control computer 102 then instructs the automation control system 122 to return the employee's office to the employee's preferred working conditions.

When the employee leaves the office building at the end of the day, the employee alerts the PEM system 100 as described above. Thereafter, according to the default profile, the system control computer 102 instructs the automation control system 122 to turn off the employee's office lights, adjust the employee's office temp to a predetermined “unoccupied” setting, and put the employee's computer and peripheral devices in standby or sleep mode, or to shutdown all devices completely.

In addition to controlling the environment of each employee's personal work space, the PEM system 100 also controls the environment in common areas, such as reception areas, bathrooms, break/lunch rooms, file rooms, copy rooms, and shared printer areas, etc. For example, at the beginning of the work day, all the above described common areas are powered on, lit, and brought to an acceptable “occupied” temperature. Similarly, at the end of the work day, all of the above described areas are powered down, and brought to an acceptable “unoccupied” temperature.

The time that these environmental control events occur in these common areas depend on the particular employees that use these areas. For example, if all the employees that use a particular rest room and break room do not start their work day until 11 A.M., then the system control computer 102 will not instruct the automation control system 122 to turn on the lights or provide heat/AC to those areas until 11 A.M., or until at least one employee alerts the PEM system 100 of his/her arrival, as described above. Likewise, these areas would be powered down, as described above, only after the last employee that frequents these areas alerts the PEM system of his/her departure.

The PEM system 100 also adjusts the office environment for a particular employee when the employee is in the office on a weekend, holiday, or after typical work hours. For example, assume that the building level 200 has been shut down by the automation control system 122 for a long winter holiday weekend. In other words, lights are turned off (excluding emergency lights), the phones are turned off, the computers and peripherals are shutdown, and the temperature is lowered to conserve energy. Next assume employee A enters the building level 200 on one of the holiday weekend days. When employee A enters the reception area 202, employee A makes his/her presence known to (i.e., registers with) the PEM system 100 by interacting with the presence detecting apparatus 222a, as described in detail above. Thereafter, the system control computer 102 retrieves the PEM profile of employee A to determine the particular employee's environmental preferences and to determine the common areas that the employee uses. The system control computer 102 then instructs the automation control system 122 to configure the office environment accordingly.

Specifically, the automation control system 122 turns on the lights in the reception area 202 (point of entry for employee A), the hallway 220c (i.e., hallway used by employee A to get to office 204c), adjusts the office temperature and lighting in office 204c (office of employee A) according to the employee's preferences, wakes up/turns on the employee's computer and peripherals, and turns on lights and provides power and heat/AC to the particular common areas that employee A uses, such as the break room 218 and the men's room 210. Further assume for this example that a secretary for employee A works at the secretary station 206f. The automation control system 122 also turns on any lights and office equipment (e.g., copier, fax, printer/scanner) located in secretary station 206f that employee A might need. All other areas of the office level 200 that are not occupied by an employee, or needed by an employee present elsewhere on level 200, remain powered down for the long holiday weekend, thus conserving energy.

In an alternative embodiment, the PEM system 100 configures the employee's office environment based on the employee's schedule stored in the employee's PEM profile. For example, if the employee normally arrives at his office at 9 A.M. the PEM system 100 raises the heat in the employee's office some predetermined time prior to the employee's arrival so that the employee's office is at the preferred temperature when the employee arrives.

In another embodiment, the PEM system 100 configures the environment in a particular common areas based on the particular employees who contemporaneously use the common area. For example, the PEM system 100 configures the environment in a conference room based on the number of employees using the conference room and based on the preferences listed in each employee's personal PEM profile.

For example, the PEM system 100 is alerted by scheduling software that a particular conference room (e.g., room 216a or 216b) will be needed for a meeting at a particular time and will have a particular number of attendees. In one configuration, the PEM system 100 only knows the number of attendees. In another configuration, the PEM system 100 knows the identities of each of the attendees.

In the case where only the number of attendees is known, the system control computer 102 instructs the automation control system 122 to adjust the environment in the conference room at some time prior to the meeting by turning on the lights, turning on any necessary peripheral devices (e.g., projector, computer, television, etc.), and adjusting the temperature and humidity according to a human comfort curve based on the size of the room, the number of attendees, and the presumed size/weight (average characteristics) of the attendees. After the attendees arrive, the system control computer 102 continues to monitor the conference room and adjusts the temperature and humidity based on the number of people that actually attend. For example, more or less people may attend, thus requiring the system control computer 102 to instruct the automation control system 122 to decrease or increase the temperature accordingly. Alternatively, the expected number of invitees actually attends the meeting, but due to overall increased or decreased body mass, the temperature may need to be decreased or increased accordingly.

In the case where the identities of at least some of attendees are known, the system control computer 102 retrieves the known employees' PEM profiles and instructs the automation control system 122 to adjust the environment in the conference room at some time prior to the meeting by turning on the lights, turning on any necessary peripheral devices (e.g., projector, computer, television, etc), and adjusting the temperature and humidity according to a human comfort curve based on the size of the room, the number of attendees, the overlap in temperature preferences for known employees, and the presumed size/weight (average characteristics) of the unknown attendees. After the attendees arrive, and are identified by the system control computer 102 (via personal remote, RFID card, facial recognition), the system control computer 102 retrieves the PEM profiles of attendees who are employees of the company and instructs the automation control system 122 to adjust the temperature and humidity based the actual number of attendees, the overlap in temperature preferences for the employees in attendance, and the presumed size/weight (average characteristics) of any unknown attendees (e.g., visitors, customers, clients). The system control computer 102 continues to monitor the conference room and adjust the temperature and humidity as people join or leave the meeting, as described above.

In another embodiment, the PEM system 100 automatically reroutes phone calls for each of the known attendees from their respective office phones to the conference room phones for the duration of the meeting or for as long as the employee attends the meeting.

In still another embodiment, the PEM system 100 makes any documents or applications on an attendee's computer available/accessible on a computer in the conference room for the duration of the meeting.

The system control computer 102 in conjunction with a scheduling program configures the environment of the conference room or other common room for a specific period of time. However, occasionally, a meeting will continue past the scheduled end time. In this case, as long as the system control computer 102 detects at least one person in the conference room, the system control computer 102 will continue to maintain the environmental settings. If no presence is detected (via motion sensor, camera) after the scheduled end time of the meeting, the system control computer will after a short delay (e.g., 5 minutes) instruct the automation control system to turn off the lights and peripheral devices, and maintain the temperature at a level suitable for an empty room.

In the case where a common room, such as a conference room, is scheduled for use (e.g., a meeting), and the environment in the room is adjusted by the automation control system 122 (under control of the system control computer 102) to accommodate certain invitees, and no one attends the meeting, the system control computer 102 will wait for some predetermined amount of time (e.g., 15 minutes) after the scheduled start time of the meeting before instructing the automation control system 122 to return the room's environment to a non-occupied state (i.e., lights and devices off).

It should be noted that the system control computer 102, when instructing the automation control system 122 to raise or lower temperature/humidity in a conference room, other public area, or employee office/cube/lab, first determines the minimum energy path (i.e., cheapest approach) for reaching the desired temperature. For example, it may be cheaper to decrease the humidity rather than increase the air conditioning to reach a desired temperature.

In another embodiment, in the event of an emergency, the system control computer 102 uses employee location data obtained by the plurality of motion sensors 112 and cameras 114, and controls the office building security system 344 to direct employees to the nearest exit. Further, in the event of an emergency, the system control computer 102 instructs the automation control system 122 to shut down computers, HVAC, and other non-essential devices.

In still another embodiment, the motion sensors 112 and cameras 114 of the PEM system 100 are used to determine traffic patterns within the office building. For example, the motion sensors 112 can be used to determine if a particular flight of stairs or elevator is used frequently or not. If a particular set of stairs in a closed stairwell are not used frequently, the particular set of stairs may be not heated in the winter or cooled in the summer. Likewise, if a particular elevator is not frequently used, the particular elevator may be taken out of service to save power.

In yet another embodiment, the system control computer is in communication with one or more meters that measure electricity/power usage. In this embodiment, the system control computer 102 generates various energy usage reports. These reports can be generated with any frequency and for any time period. Further, the energy usage reports can be generated to report energy usage of particular employees, groups of employees, sections/zones of the office building, and/or of the entire building.

With the above-described energy management system, each employee can configure his/her individual work environment to best accommodate his/her specific needs. Consequently, energy for heat, air conditioning, lighting, etc., is not wasted in cases where a particular employee requires less than the average person (e.g., dimmer lights, less air conditioning, etc.). Further, lower energy use by some employees allows other employees to use more energy when necessary (e.g., more heat, more air conditioning) without resulting in an increase in cumulative energy use. Moreover, energy is consistently saved when employees leave or are absent.

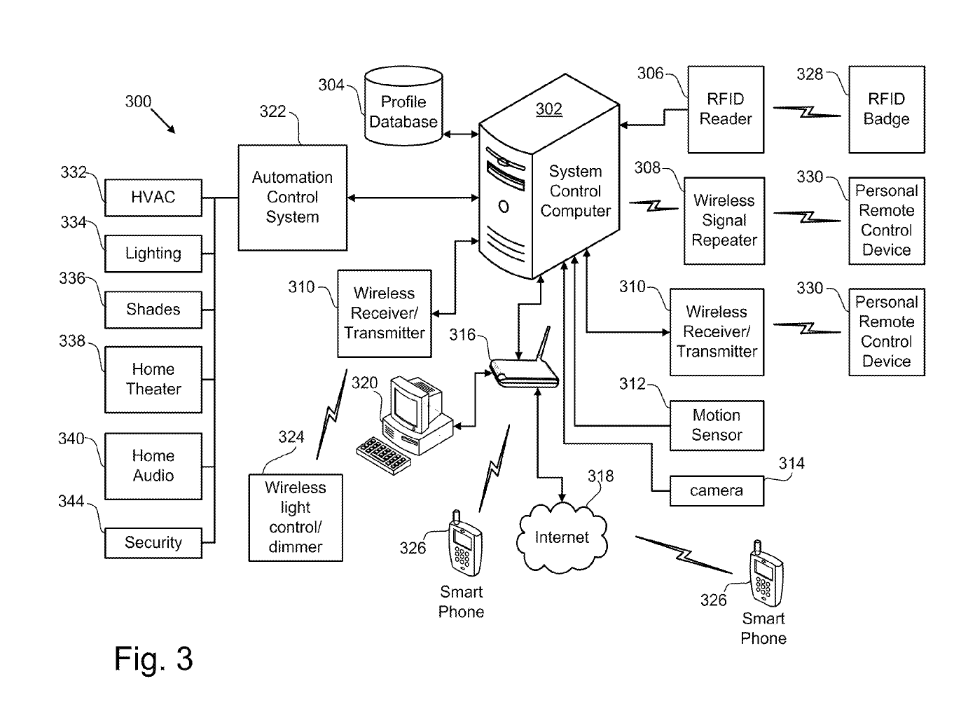

Referring to FIG. 3, in another embodiment, a personal energy management system 300 in a domestic/home environment is shown. The system 300 includes a system control computer 302, a profile database 304, and an automation control system 322. In various embodiments, the personal energy management system 300 further includes at least one RFID reader 306, at least one wireless signal repeater 308 (e.g., an IR signal repeater), at least one wireless receiver/transmitter 310 (e.g., an IR receiver/transmitter), at least one motion sensor 312, and at least one camera 314. In various embodiments, a plurality of RFID readers 306, and/or a plurality of wireless signal repeaters 308, and/or a plurality of wireless receiver/transmitters 310, and/or a plurality of motion sensors 312, and/or a plurality of cameras 114 are disposed throughout a building employing the PEM system 300.

The automation control system 322 controls HVAC 332, humidity, outlet (A/C) power, lighting 334, wireless light controllers/dimmers 324, window shades/drapes 336, phones 138, home theater 338, home audio 340, and security/emergency systems 344. The system control computer 302 is in wired or wireless communication with the at least one RFID reader 306, the at least one wireless signal repeater 308, the at least one wireless receiver/transmitter 310, the at least one motion sensor 312, and the at least one camera 314. The system control computer 302 includes software, which resides and executes thereon, that is used to configure and control the PEM system 300. Such software is written in any acceptable computer language known to those skilled in the art.

The profile database 304 is used to store personal energy management (PEM) profiles and various default energy management profiles, which are discussed in detail below. In one embodiment, the profile database 304 is stored separately from the system control computer 302. In another embodiment, the profile database 304 is stored on the system control computer 302. The system control computer 302 is also in wired or wireless communication with a Wi-Fi router 316 (local area network) 116, which is in communication with the internet 318 or World Wide Web. The system control computer 302 can be accessed and configured directly through a connected terminal or remotely via a connected personal computer 320.

Each family member (i.e., user) has a personal energy management (PEM) profile stored in the profile database 304. The user's PEM profile includes data and preferences relating to the user's preferred living environment. Such data and preferences include, but are not limited to, bedroom location, home/school/work schedule, bathroom used by the family member, preferred room temperature, preferred room light levels (e.g., on, off, percent dimmed), preferred shade or drape position (e.g., open, closed, percent open), and preferred audio/video settings/choices. In various embodiments, each family member can creates and configures their own PEM profile stored in the profile database 304 via any computer/terminal 320, smart phone 326, or device communication with the home LAN 316, or via a computer/terminal or smart phone in communication with the internet 318.

Default energy management profiles are also stored in the profile database 304. The default profiles are used to configure the home environment for minimum energy usage when users are absent, (e.g., at work, at school, running errands). In another embodiment, the default settings for the devices in the user's home environment are included in the user's personal energy management profile.

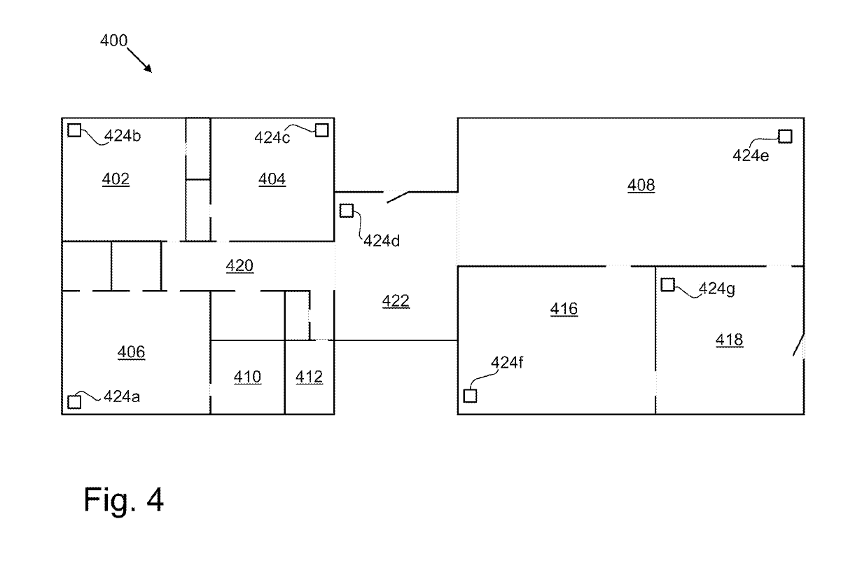

Referring to FIG. 4, an illustrative block diagram of a floor/level 400 of a house is shown. The level 400 includes bedrooms 402, 404, 408, bathrooms 410, 412, hallway 420, foyer 422, living room 406, dining room 416, and kitchen 418.

Disposed at various locations throughout the house 400 are presence detecting apparatuses 424a-g. In various embodiments, each presence detecting apparatus 424a-g is the RFID reader 306, the wireless signal repeater 308, the wireless receiver/transmitter 310, the motion sensor 312, the camera 314, or router 316 mentioned above with respect to FIG. 3.

In operation, when a family member (user) arrives home, the family member makes his/her presence known to (i.e., registers with) the PEM system 100 by interacting with one of the presence detecting apparatuses 424a-g. In one embodiment, interacting with one of the presence detecting apparatuses 424a-g involves the user actuating a wireless personal remote control device 330, such as an infrared, Wi-Fi, or Bluetooth remote control, for example, and transmitting a unique digital presence signal, which is detected/received by one of the wireless receiver/transmitters 310 disposed throughout the house 400. The wireless receiver/transmitter 310 then transmits the unique digital presence signal to the system control computer 302. In another embodiment, the signal from the user's personal remote control device 330 is read by a wireless signal repeater 308 and passed to the system control computer 302.

In still another embodiment, interacting with one of the presence detecting apparatuses 424a-g involves the user presenting his/her personal RFID badge 328 to the RFID reader 306. The RFID reader 306 detects/reads the user's personal RFID badge 328 and transmits the unique digital presence signal to the system control computer 302. For example, the user's RFID badge 328 could be read by the RFID reader 306 when the user uses a cardkey to interact with a home security system. In another embodiment, interacting with one of the presence detecting apparatuses 424a-g involves the user entering a personal access code via a keypad of a home security system.

In yet another embodiment, interacting with one of the presence detecting apparatuses 424a-g involves the user connecting to (logging on to) the home LAN 316 with a Wi-Fi enabled smart phone 326.

In still another embodiment, interacting with one of the presence detecting apparatuses 424a-g involves the user being detected by the motion detectors 312. In this embodiment, sustained motion detected in a family member's bedroom is an indication that the family member assigned to that bedroom is present. Brief motion detection would be interpreted as a visitor entering the bedroom.

In yet another embodiment, interacting with one of the presence detecting apparatuses 424a-g involves the user being detected by the cameras 314. The cameras 314 function in conjunction with facial recognition software residing and executing on the system control computer 302. In this embodiment, as a security requirement for entry, a user would be required to look directly at a camera and wait until the facial recognition software made a positive identification.

Upon receiving the user's unique digital presence signal, the system control computer 302 retrieves a corresponding user PEM profile from the profile database 304. The system control computer 102 uses the data and preferences in the user's PEM profile to instruct the automation control system 322 to configure the environment in the user's bedroom, or other room exclusively occupied by the user, such as a sewing room, study, or home office. For example, if the user prefers a brightly lit room, with natural light, and a temperature of 75 degrees Fahrenheit, the system control computer 302 instructs the automation control system 322 to adjust the lighting, shade position, and temperature in the user's bedroom accordingly.

The system control computer 302 also uses the data and preferences in the user's PEM profile to instruct the automation control system 322 to configure the environment in a particular common room, such as a living room, when that user is the only person in that particular common room. The system control computer 302 also instructs the automation control system 322 to turn on any devices according to the user's preferences, such as a computer, printer, stereo, and/or television.

Still referring to FIG. 4, as a further example, assume two family members) (user A and user B) enter the foyer 422. Further assume that user A resides in bedroom 406 and uses bathroom 410, and user B resides in bedroom 404 and uses bathroom 412. Upon the two family members entering the foyer 422, the presence detecting apparatus 424d detects the presence of both users through one of the methods described in detail above.

The system control computer 102 retrieves the energy management profiles for user A and user B from the profile database 304. The system control computer 302 then instructs the automation control system 322 to adjust the lighting, shade position, and temperature in bedroom 406 and bathroom 410 according user A's profile and instructs the automation control system 322 to adjust the lighting, shade position, and temperature in bedroom 404 and bathroom 412 according user B's profile. The system control computer 302 also instructs the automation control system 322 to turn on any devices preferred by user A and user B, such as a computer, stereo, television, etc.

In one embodiment, when a particular family member (e.g., user A or B) leaves the house 400, the user either alerts the system control computer 302 of his departure (i.e., imminent absence) using his/her personal remote control 330, or RFID badge 328. In another embodiment, the system control computer 102 is alerted to the user's departure/absence when the user's smart phone 326 is disconnected from the home network 316.

Upon detecting the user's departure/absence, the system control computer 302 retrieves a default profile from the database 304. The system control computer 302 then, according to the default profile, instructs the automation control system 322 to turn off the user's bedroom lights, adjust the user's bedroom temperature to a predetermined “unoccupied” setting, and turn off any other devices.

In another embodiment, motion sensors 314 disposed in each room are used to determine if a family member is actually in a particular room that has been configured for that family member's use. If the family member leaves a room for an extended period of time, such that no motion is detected by the motion detectors for longer than a preset time out period, the system control computer 302 instructs the automation control system 322 to turn off lights and other devices, such as a television or stereo.

When the user returns to the house 400, the user again makes his/her presence known to (i.e., reconnects with) the PEM system 100 as described above. The system control computer 102 then instructs the automation control system 122 to return the user's bedroom or other preferred room to the user's preferred environmental conditions (e.g., lighting, temperature, etc.).

In addition to controlling the environment of each family member's bedroom, the PEM system 100 also controls the environment in common areas, such as the kitchen 418, living room 408, dining room 416, etc. For example, when at least one family member arrives home and is detected by the presence detecting apparatus 424a-g, all the above-described common areas are at least brought to an acceptable temperature. Likewise, if no one is home, all of the above described areas have their lights turned off, temperature adjusted, and resident devices turned off. In some embodiments, various lights are left on as part of a security system configuration that is automatically implemented by the automation control system 322 when no one is home, or when a single person is home alone.

In an alternative embodiment, the PEM system 300 configures the family member's home environment based on the family member's schedule stored in the family member's PEM profile. For example, if children normally arrive home from school at 3 P.M. the system control computer 302 instructs the automation control system 322 to raise the heat in each of the children's rooms and in the home overall at a time prior to the children's arrival so that the children's rooms and the house overall are at the preferred temperatures when the children arrive.

In another embodiment, the PEM system 300 configures the environment in a particular common areas based on the family members (and guests) who contemporaneously use the common area. For example, the PEM system 300 configures the environment in a TV room based in one of two ways. In one configuration, the PEM system 300 only knows the number of people present. In another configuration, the PEM system 300 knows the identities of at least some each of the attendees (i.e., at least one family member).

In the case where only the number of people present is known, the system control computer 302 instructs the automation control system 322 to adjust the environment in the TV room by turning on the lights, turning on any necessary peripheral devices (e.g., projector, computer, television, etc.), and adjusting the temperature and humidity according to a human comfort curve based on the size of the room, the number of people present, and the presumed size/weight (average characteristics) of the attendees. The system control computer 302 continues to monitor the TV room and adjusts the temperature and humidity based on the number of people that are actually present. For example, more or less people may be present, thus requiring the system control computer 302 to instruct the automation control system 322 to decrease or increase the temperature accordingly.

In the case where the identities of at least some of the people present are known (i.e., family members), the system control computer 302 retrieves the known PEM profile for each family member present and instructs the automation control system 322 to adjust the environment in the TV room by turning on the lights, turning on any necessary peripheral devices (e.g., projector, computer, television, etc), and adjusting the temperature and humidity according to a human comfort curve based on the size of the room, the number of attendees, the overlap in temperature preferences for the present family members, and the presumed size/weight (average characteristics) of the unknown attendees. The system control computer 302 continues to monitor the TV room and adjusts the temperature and humidity as people arrive and leave, as described above.

In another embodiment, in the event of an emergency, the system control computer 302 uses family member location data obtained by the plurality of motion sensors 312 and cameras 314, and controls the home security system 344 to direct family members to the nearest exit. Further, in the event of an emergency, the system control computer 302 instructs the automation control system 322 to shut down HVAC and all non essential devices.

In yet another embodiment, the system control computer 302 is in communication with one or more meters that measure electricity/power usage. In this embodiment, the system control computer 302 generates various energy usage reports. These reports can be generated with any frequency and for any time period. Further, the energy usage reports can be generated to report energy usage of particular family members, groups of family members, sections/zones of the residence, and/or of the entire home.

With the above-described energy management system, each family member can configure his/her individual home environment to best accommodate his/her specific needs. Consequently, energy for heat, air conditioning, lighting, etc., is not wasted in cases where a particular family member requires less than the average person (e.g., dimmer lights, less air conditioning, etc.). Further, lower energy use by some family members allows other family members to use more energy when necessary (e.g., more heat, more air conditioning) without resulting in an increase in cumulative energy use. Moreover, energy is consistently saved when family members leave the house.

### LIST OF ACRONYMS USED IN THE DETAILED DESCRIPTION OF THE INVENTION

The following is a list of the acronyms used in the specification in alphabetical order.
A/C alternating current
A/V audio/video
HVAC heating, ventilation, and air conditioning
IR infrared
LAN local area network
PC personal computer
PEM personal energy management
RFID radio frequency identification
TV television
WAN wide area network
Wi-Fi wireless fidelity

### Alternate Embodiments

Variations, modifications, and other implementations of what is described herein may occur to those of ordinary skill in the art without departing from the spirit and scope of the invention. Accordingly, the invention is not to be defined only by the preceding illustrative description.

What is claimed is:

1. A system for managing energy usage of a user, the system comprising:
a database configured for storing a preferred energy profile associated with the user, and a minimum energy profile;
an automation control system configured for controlling at least one device associated with the user;
a presence detecting apparatus configured for detecting when the user is present; and
a system control computer in communication with the automation control system and the presence detecting apparatus, the system control computer being configured for instructing the automation control system to operate the at least one device according to the preferred energy profile associated with the user in response to the presence detecting apparatus detecting the presence of the user, and for instructing the automation control system to operate the at least one device according to the minimum energy profile in response to the presence detecting apparatus detecting the absence of the user.

2. The system according to claim 1, wherein the presence detecting apparatus comprises an RFID reader, a wireless receiver, a motion sensor, or a camera.

3. The system according to claim 2, wherein the wireless receiver comprises an infrared signal receiver, a Wi-Fi receiver, or a Bluetooth receiver.

4. The system according to claim 1, wherein the automation control system controls at least one of HVAC equipment, humidity, lighting, shade position, curtain position audio devices, video devices, computers, security equipment, home audio equipment, and home theater equipment.

5. The system according to claim 1, further comprising a remote computing device in wired or wireless communication with the system control computer configured for creating or editing the preferred energy profile associated with the user.

6. The system of claim 1, wherein the system control computer is further configured for generating energy usage reports.

7. The system of claim 1, wherein the at least one device comprises one of a thermostat, a light controller, a shade motor, and a computer.

8. The system of claim 1, wherein the energy management profile comprises data corresponding to device settings for preferred temperature, preferred light levels, and preferred shade position.

9. The system of claim 1, wherein the minimum energy profile comprises data corresponding to device settings for minimum energy usage.

10. A method of managing energy usage of a user, the method comprising:
storing in a database a preferred energy profile associated with the user, and a minimum energy profile;
detecting the presence of the user in a particular location;
retrieving the preferred energy profile associated with the user in response to detecting the presence of the user in the particular location;
operating one or more devices disposed in the particular location according to the retrieved preferred energy profile;
retrieving the minimum energy profile in response to detecting the absence of the user from the particular location; and
operating the one or more devices disposed in the particular location according to the retrieved minimum energy profile.

11. The method of claim 10, wherein operating the one or more devices disposed in the particular location according to the retrieved preferred energy profile comprises adjusting the temperature, the light levels, and the shade position according to user preferences.

12. The method of claim 10, wherein operating the one or more devices disposed in the particular location according to the retrieved minimum energy profile comprises adjusting the one or more devices for minimum energy usage.

13. The method of claim 10, further comprising generating an energy usage report.

14. A system for configuring a user's environment within a building, the system comprising:
a database configured for storing a preferred energy profile associated with the user, and a minimum energy profile;
an automation control system configured for controlling a plurality of devices associated with the user, at least some of the plurality of devices being disposed in separate rooms of the building;
at least one presence detecting apparatus configured for detecting when the user is present in the building; and
a system control computer in communication with the automation control system and the at least one presence detecting apparatus, the system control computer being configured for instructing the automation control system to operate the plurality of devices according to the preferred energy profile associated with the user in response to the at least one presence detecting apparatus detecting the presence of the user in the building, and for instructing the automation control system to operate the plurality of devices according to the minimum energy profile in response to the presence detecting apparatus detecting the absence of the user from the building.

15. The system according to claim 14, wherein the at least one presence detecting apparatus comprises one of an RFID reader, a wireless receiver, a motion sensor, and a camera.

16. The system according to claim 15, wherein the wireless receiver comprises an infrared signal receiver, a Wi-Fi receiver, or a Bluetooth receiver.

17. The system according to claim 14, wherein the automation control system controls at least one of HVAC equipment, humidity, lighting, shade position, curtain position audio devices, video devices, computers, security equipment, home audio equipment, and home theater equipment.

18. The system according to claim 14, further comprising a remote computing device in wired or wireless communication with the system control computer configured for creating or editing the preferred energy profile associated with the user.

19. The system of claim 14, wherein one of the plurality of devices comprises one of a thermostat, a light controller, a shade motor, and a computer.

20. The system of claim 14, wherein the energy management profile comprises data corresponding to device settings for preferred temperature, preferred light levels, and preferred shade position, and the minimum energy profile comprises data corresponding to device settings for minimum energy usage.
